(19) United States
(12) Patent Application Publication
(10) Pub. No.: US 2020/0014021 A1
(43) Pub. Date: Jan. 9, 2020

(54) POSITIVE ELECTRODE FOR LITHIUM ION BATTERY AND LITHIUM ION BATTERY

(71) Applicant: Envision AESC Energy Devices Ltd., Sagamihara-shi, Kanagawa (JP)

(72) Inventor: Yoshihiro NIIDA, Sagamihara-shi (JP)

(73) Assignee: Envision AESC Energy Devices Ltd., Sagamihara-shi, Kanagawa (JP)

(21) Appl. No.: 16/482,507

(22) PCT Filed: Feb. 9, 2018
(86) PCT No.: PCT/JP2018/004659

§ 371 Date: Jul. 31, 2019

(30) Foreign Application Priority Data
Feb. 23, 2017 (JP) 2017-031840

(51) Int. Cl. H01M 4/131; H01M 4/525; H01M 4/505; H01M 4/62; H01M 10/0525

(52) U.S. Cl. CPC H01M 4/131; H01M 4/525; H01M 2004/028; H01M 4/623; H01M 10/0525; H01M 4/505

(57) ABSTRACT

A positive electrode (100) for a lithium ion battery of the present invention includes a collector layer (101); and a positive electrode active material layer (103) which is provided on each of both surfaces of the collector layer (101) and contains a positive electrode active material, a binder resin, and a conductive assistant. Further, a volume resistivity of the positive electrode (100) for a lithium ion battery is greater than or equal to 120 Ω·m and less than or equal to 350 Ω·m, and in a case where a specific surface area of the positive electrode active material contained in the positive electrode active material layer (103) is set as S [m²/g] and a content of the conductive assistant in the positive electrode active material layer (103) is set as W [% by mass] , S/W is greater than or equal to 0.080 and less than or equal to 0.140.

### TECHNICAL FIELD

The present invention relates to a positive electrode for a lithium ion battery and a lithium ion battery.

### BACKGROUND ART

Since lithium ion batteries have a high energy density and excellent charge and discharge cycle characteristics, the lithium ion batteries have been widely used as power sources and the like for small mobile devices such as mobile phones or notebook computers.

In recent years, due to the consideration for environmental issues and increased awareness of energy saving, there has been a growing demand for large-sized batteries required to have a large capacity and a long service life for electric vehicles, hybrid electric vehicles, electricity storage fields, and the like.

In order to achieve a high energy density and a long service life, further improvement of the characteristics of lithium ion batteries has been required.

A positive electrode used for a lithium ion battery is typically formed of a positive electrode active material layer and a collector layer. A positive electrode active material layer is obtained by coating a surface of a collector layer such as metal foil with a positive electrode slurry containing a positive electrode active material, a binder resin, and a conductive assistant and drying the surface.

As the techniques for such positive electrodes for lithium ion batteries, those described in Patent Documents 1 to 3 are exemplified.

Patent Document 1 (Japanese Unexamined Patent Publication No. H08-17471) describes a nonaqueous electrolytic solution secondary battery including: a positive electrode, a negative electrode, and a nonaqueous electrolytic solution which contains a lithium ion, in which a lithium manganese oxide represented by Formula Li[Mn_{2-X}Li_{X}]O₄ (here, 0≤x≤0.1) or a lithium manganese oxide represented by Formula Li[Mn_{2-X}M_{X}]O₄ (here, M represents a metal element other than Mn such as Co, Ni, Fe, Cr, Zn, or Ta) is used as an active material of the positive electrode, the positive electrode is an electrode whose active material layer is formed by hardening the lithium manganese oxide having a specific surface area (S) of smaller than or equal to 0.5 m²/g on a metal collector together with a conductive assistant, and a density (d) of the active material layer is greater than or equal to 2.85 and smaller than or equal to 3.2 g/cc.

Patent Document 2 (Japanese Unexamined Patent Publication No. 2000-251892) describes a positive electrode active material for a lithium secondary battery which is formed by mixing a lithium nickel composite oxide represented by Compositional Formula LiNi₁₋ₓM1ₓO₂ (M1 represents at least one metal element from among Al, B, an alkali metal, an alkaline earth metal, and a transition metal element: 0 <x<0.3) with a lithium manganese composite oxide represented by Compositional Formula LiMn_{2-y}M2_{y}O₄ (M2 represents at least one metal element from among Al, B, an alkali metal, an alkaline earth metal, and a transition metal element: 0<y<0.3).

Patent Document 3 (Japanese Unexamined Patent Publication No. 2013-20975) describes a nonaqueous electrolyte secondary battery including: a positive electrode mixture layer which contains a layered lithium-manganese-nickel-cobalt composite oxide containing at least Mn, Ni, and Co and a spinel type lithium-manganese composite oxide as active materials, in which the layered lithium-manganese-nickel-cobalt composite oxide has a specific surface area of 0.1 to 0.6 m²/g, the spinel type lithium-manganese composite oxide has a specific surface area of 0.05 to 0.3 m²/g, a ratio of a content of the spinel type lithium-manganese composite oxide to a total content of the layered lithium-manganese-nickel-cobalt composite oxide and the spinel type lithium-manganese composite oxide in the positive electrode mixture layer is in a range of 30% to 50% by mass, a molar ratio of Li to Mn is in a range of 0.35 to 0.53, a density of the positive electrode mixture layer is in a range of 3.0 to 3.6 g/cm³, and the positive electrode mixture layer has a positive electrode containing at least acetylene black as a conductive assistant.

### RELATED DOCUMENT

### Patent Document

[Patent Document 1] Japanese Unexamined Patent Publication No. H08-17471

[Patent Document 2] Japanese Unexamined Patent Publication No. 2000-251892

[Patent Document 3] Japanese Unexamined Patent Publication No. 2013-20975

### SUMMARY OF THE INVENTION

### Technical Problem

With a demand for miniaturization or weight reduction of lithium ion batteries, the lithium ion batteries are required to have higher energy density.

According to the examination conducted by the present inventors, it was found that the cycle characteristics at a high temperature may be deteriorated in a case where the energy density of lithium ion batteries is increased by employing a positive electrode active material with a high capacity, increasing the density of electrodes, or making the thickness of the active material layer larger.

The present invention has been made in consideration of the above-described circumstances, and an object thereof is to provide a positive electrode for a lithium ion battery which is capable of realizing a lithium ion battery with excellent cycle characteristics at a high temperature.

### Solution to Problem

The present inventors repeatedly conducted intensive examination in order to solve the above-described problems. As the result, it was found that deterioration of the cycle characteristics at a high temperature can be suppressed by setting the volume resistivity of a positive electrode and the ratio of the specific surface area of a positive electrode active material to the content of a conductive assistant to be respectively in a specific range even in a case where a positive electrode active material with a high capacity is employed, the density of electrodes is increased, or the thickness of an active material layer is made larger so that the energy density of lithium ion batteries is increased, thereby completing the present invention.

According to the present invention, there is provided a positive electrode for a lithium ion battery, including: a collector layer; and a positive electrode active material layer which is provided on each of both surfaces of the collector layer and contains a positive electrode active material, a binder resin, and a conductive assistant, in which a volume resistivity of the positive electrode for a lithium ion battery is greater than or equal to 120 Ω·m and less than or equal to 350 Ω·m, and in a case where a specific surface area of the positive electrode active material contained in the positive electrode active material layer is set as S [m²/g] and a content of the conductive assistant in the positive electrode active material layer is set as W [% by mass], S/W is greater than or equal to 0.080 and less than or equal to 0.140.

Further, according to the present invention, there is provided a lithium ion battery including: the positive electrode for a lithium ion battery.

### Advantageous Effects of Invention

According to the present invention, it is possible to provide a positive electrode for a lithium ion battery which is capable of realizing a lithium ion battery with excellent cycle characteristics at a high temperature.

### BRIEF DESCRIPTION OF THE DRAWINGS

The above-described purpose and other purposes, features, and advantages will become more apparent based on the preferred embodiments described below and the accompanying drawings.

FIG. 1 is a cross-sectional view illustrating an example of a structure of a positive electrode for a lithium ion battery according to an embodiment of the present invention.

FIG. 2 is a cross-sectional view illustrating an example of a structure of a lithium ion battery according to an embodiment of the present invention.

### DESCRIPTION OF EMBODIMENTS

Hereinafter, embodiments of the present invention will be described with reference to the accompanying drawings. In all drawings, the same constituent elements are denoted by the same reference numerals, and the description thereof will not be provided. Further, the shape, the size, and the positional relationship of each constituent element in the drawings are schematically shown in order to facilitate the understanding of the present invention, and the size thereof is different from the actual size. Further, the numerical ranges “A to B” in the present embodiment indicate greater than or equal to A and less than or equal to B unless otherwise specified.

### Positive Electrode for Lithium ion Battery

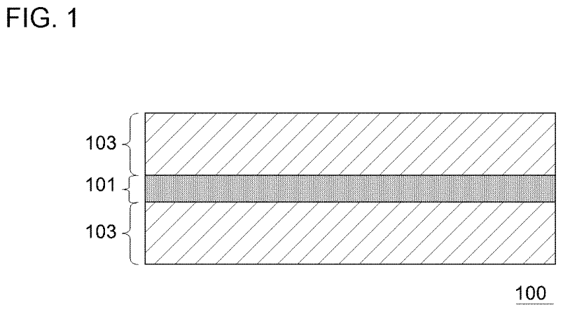

First, a positive electrode 100 for a lithium ion battery according to the present embodiment will be described. FIG. 1 is a cross-sectional view illustrating an example of the structure of the positive electrode 100 for a lithium ion battery according to the embodiment of the present invention.

The positive electrode 100 for a lithium ion battery according to the present embodiment includes a collector layer 101; and a positive electrode active material layer 103 which is provided on each of both surfaces of the collector layer (101) and contains a positive electrode active material, a binder resin, and a conductive assistant. Further, the volume resistivity of the positive electrode 100 for a lithium ion battery is greater than or equal to 120 Ω·m and less than or equal to 350 Ω·m, and in a case where the specific surface area of the positive electrode active material contained in the positive electrode active material layer 103 is set as S [m²/g] and the content of the conductive assistant in the positive electrode active material layer 103 is set as W [% by mass], S/W is greater than or equal to 0.080 and less than or equal to 0.140.

Here, the volume resistivity of the positive electrode 100 for a lithium ion battery can be measured using a four-terminal resistivity measuring device according to a four terminal method. More specifically, the volume resistivity of the positive electrode 100 for a lithium ion battery can be measured by interposing the positive electrode 100 for a lithium ion battery using a terminal probe in the normal direction of the thickness thereof at a load of 1 kg/cm² and connecting a measurement terminal to this terminal probe according to the four terminal method.

According to the examination conducted by the present inventors, it became evident that the cycle characteristics at a high temperature may be deteriorated in a case where the energy density of lithium ion batteries is increased by employing a positive electrode active material with a high capacity, increasing the density of electrodes, or making the thickness of the active material layer larger.

As the result of intensive examination conducted by the present inventors, it was found that deterioration of the cycle characteristics at a high temperature can be suppressed by setting the volume resistivity of a positive electrode and the ratio of the specific surface area of a positive electrode active material to the content of a conductive assistant to be respectively in a specific range even in a case where a positive electrode active material with a high capacity is employed, the density of electrodes is increased, or the thickness of an active material layer is made larger so that the energy density of lithium ion batteries is increased, thereby completing the present invention.

The upper limit of the volume resistivity of the positive electrode 100 for a lithium ion battery is less than or equal to 350 Ω·m, preferably less than or equal to 300 Ω·m, more preferably less than or equal to 250 Ω·m, still more preferably less than or equal to 200 Ω·m, and particularly preferably less than or equal to 180 Ω·m.

In the positive electrode 100 for a lithium ion battery according to the present embodiment, since the electric resistance of a lithium ion battery to be obtained can be reduced by setting the volume resistivity to be less than or equal to the above-described upper limit, an increase in thickness of a coated film due to side reactions (such as a decomposition reaction of an electrolytic solution and the like) at the electrode can be suppressed, and thus the characteristics of the battery such as cycle characteristics can be effectively improved.

The lower limit of the volume resistivity of the positive electrode 100 for a lithium ion battery is greater than or equal to 120 Ω·m, preferably greater than or equal to 130 Ω·m, and more preferably greater than or equal to 140 Ω·m.

In the positive electrode 100 for a lithium ion battery according to the present embodiment, since the electrode reaction can be appropriately suppressed by setting the volume resistivity to be greater than or equal to the above-described lower limit, it is possible to suppress cracking of the positive electrode active material due to expansion or contraction and prevent an extreme load from being applied to the positive electrode active material. As the result, the characteristics of the battery such as cycle characteristics can be effectively improved.

The volume resistivity of the positive electrode 100 for a lithium ion battery according to the present embodiment can be realized by highly controlling the production conditions such as (A) the compounding ratio of the positive electrode active material layer 103, (B) a method of preparing a positive electrode slurry used for forming the positive electrode active material layer 103, (C) a method of drying the positive electrode slurry, (D) a method of pressing the positive electrode, (E) an environment for preparing the positive electrode, and the like.

In the positive electrode 100 for a lithium ion battery according to the present embodiment, the upper limit of S/W of the positive electrode active material layer 103 is less than or equal to 0.140, preferably less than or equal to 0.130, and more preferably less than or equal to 0.120.

In the positive electrode 100 for a lithium ion battery according to the present embodiment, since the electric resistance of a lithium ion battery to be obtained can be reduced by setting S/W of the positive electrode active material layer 103 to be less than or equal to the above-described upper limit, an increase in thickness of a coated film due to side reactions (such as a decomposition reaction of an electrolytic solution and the like) at the electrode can be suppressed, and thus the characteristics of the battery such as cycle characteristics can be effectively improved.

The lower limit of S/W of the positive electrode active material layer 103 is greater than or equal to 0.080, preferably greater than or equal to 0.085, and particularly preferably greater than or equal to 0.090.

In the positive electrode 100 for a lithium ion battery according to the present embodiment, since the electrode reaction can be appropriately suppressed by setting the S/W of the positive electrode active material layer 103 to be greater than or equal to the above-described range, it is possible to suppress cracking of the positive electrode active material due to expansion or contraction and prevent an extreme load from being applied to the positive electrode active material. As the result, the characteristics of the battery such as cycle characteristics can be effectively improved.

Next, each component that constitutes the positive electrode active material layer 103 according to the present embodiment will be described.

The positive electrode active material layer 103 contains a positive electrode active material, a binder resin, and a conductive assistant.

The positive electrode active material contained in the positive electrode active material layer 103 according to the present embodiment is appropriately selected depending on the applications thereof.

The positive electrode active material is not particularly limited as long as the positive electrode active material is a typical material which can be used for a positive electrode for a lithium ion battery. Examples thereof include a composite oxide of lithium and a transition metal such as a lithium-nickel composite oxide, a lithium-cobalt composite oxide, a lithium-manganese composite oxide, a lithium-nickel-manganese composite oxide, a lithium-nickel-cobalt composite oxide, a lithium-nickel-aluminum composite oxide, a lithium-nickel-cobalt-aluminum composite oxide, a lithium-nickel-manganese-cobalt composite oxide, a lithium-nickel-manganese-aluminum composite oxide, or a lithium-nickel-cobalt-manganese-aluminum composite oxide; a transition metal sulfide such as TiS₂, FES, or MoS₂; a transition metal oxide such as MnO, V₂O₅, V₆O₁₃, or TiO₂; and an olivine type lithium phosphorus oxide.

The olivine type lithium phosphorus oxide contains, for example, at least one element selected from the group consisting of Mn, Cr, Co, Cu, Ni, V, Mo, Ti, Zn, Al, Ga, Mg, B, Nb, and Fe, lithium, phosphorus, and oxygen. In order to improve the characteristics of these compounds, some elements may be substituted with other elements.

Among these, an olivine type lithium iron phosphorus oxide, a lithium-nickel composite oxide, a lithium-cobalt composite oxide, a lithium-manganese composite oxide, a lithium-nickel-manganese composite oxide, a lithium-nickel-cobalt composite oxide, a lithium-nickel-aluminum composite oxide, a lithium-nickel-cobalt-aluminum composite oxide, a lithium-nickel-manganese-cobalt composite oxide, a lithium-nickel-manganese-aluminum composite oxide, or a lithium-nickel-cobalt-manganese-aluminum composite oxide is preferable; a composite oxide of lithium and a transition metal such as a lithium-nickel composite oxide, a lithium-cobalt composite oxide, a lithium-manganese composite oxide, a lithium-nickel-manganese composite oxide, a lithium-nickel cobalt composite oxide, a lithium-nickel-aluminum composite oxide, a lithium-nickel-cobalt-aluminum composite oxide, a lithium-nickel-manganese-cobalt composite oxide, a lithium-nickel-manganese-aluminum composite oxide, or a lithium-nickel-cobalt-manganese-aluminum composite oxide is more preferable; and a combination of a nickel-based composite oxide and a lithium-manganese composite oxide such as a lithium-nickel composite oxide, a lithium-nickel-manganese composite oxide, a lithium-nickel-cobalt composite oxide, a lithium-nickel-aluminum composite oxide, a lithium-nickel-cobalt-aluminum composite oxide, a lithium-nickel-manganese-cobalt composite oxide, a lithium-nickel-manganese-aluminum composite oxide, or a lithium-nickel-cobalt-manganese-aluminum composite oxide is still more preferable from the viewpoint of achieving the balance between the high capacity, the cycle characteristics, and the cost.

These positive electrode active materials have a high action potential, a high capacity, and a large energy density.

The positive electrode active materials may be used alone or in combination of two or more kinds thereof.

From the viewpoint of suppressing side reactions at the time of discharge and charge to suppress a decrease in charge and discharge efficiency, the average particle diameter of the positive electrode active material is preferably greater than or equal to 1 μm, more preferably greater than or equal to 2 μm, and still more preferably greater than or equal to 5 μm. Further, from the viewpoints of input and output characteristics and preparation of the electrode (the smoothness and the like of the surface of the electrode), the average particle diameter thereof is preferably less than or equal to 80 μm and more preferably less than or equal to 40 μm. Here, the average particle diameter indicates the particle diameter (median diameter: D50) with an integrated value of 50% in particle size distribution (on a volume basis) according to a laser diffraction scattering method.

The content of the positive electrode active material is preferably greater than or equal to 85% by mass and less than or equal to 99.4% by mass, more preferably greater than or equal to 90.5% by mass and less than or equal to 98.5% by mass, and still more preferably greater than or equal to 90.5% by mass and less than or equal to 97.5% by mass in a case where the total content of the positive electrode active material layer 103 is set to 100% by mass.

The binder resin contained in the positive electrode active material layer 103 according to the embodiment is appropriately selected depending on the applications thereof. For example, a fluorine-based binder resin which can be dissolved in a solvent can be used.

The fluorine-based binder resin is not particularly limited as long as the resin is capable of forming an electrode and sufficiently has electrochemical stability, and examples thereof include a polyvinylidene fluoride resin and fluorine rubber. These fluorine-based binder resins may be used alone or in combination of two or more kinds thereof. Among these, a polyvinylidene fluoride resin is preferable. The fluorine-based binder resin can be used by being dissolved in a solvent such as N-methyl-pyrrolidone (NMP).

The content of the binder resin is preferably greater than or equal to 0.1% by mass and less than or equal to 10.0% by mass, more preferably greater than or equal to 0.5% by mass and less than or equal to 5.0% by mass, and still more preferably greater than or equal to 1.0% by mass and less than or equal to 5.0% by mass in a case where the total content of the positive electrode active material layer 103 is set to 100% by mass. In a case where the content of the binder resin is in the above-described range, the balance between the coatability of the positive electrode slurry, the binding property of the binder, and the battery characteristics becomes further excellent.

Further, it is preferable that the content of the binder resin is less than or equal to the above-described upper limit from the viewpoint that the proportion of the positive electrode active material is increased and the capacity per positive electrode mass is increased. It is preferable that the content of the binder resin is greater than or equal to the above-described lower limit from the viewpoint that the peeling of the electrode is suppressed.

The conductive assistant contained in the positive electrode active material layer 103 according to the present embodiment is not particularly limited as long as the conductivity of the positive electrode is improved, and examples thereof include carbon black, Ketjen black, acetylene black, natural graphite, artificial graphite, and carbon fibers. Among these, carbon black, Ketjen black, acetylene black, and carbon black are preferable. These conductive assistants may be used alone or in combination of two or more kinds thereof.

The specific surface area of the conductive assistant according to a nitrogen adsorption BET method is preferably greater than or equal to 10 m²/g and less than or equal to 100 m²/g, more preferably greater than or equal to 30 m²/g and less than or equal to 80 m²/g, and particularly preferably 50 m²/g and less than or equal to 70 m²/g.

The content of the conductive assistant is preferably greater than or equal to 0.5% by mass and less than or equal to 5.0% by mass, more preferably greater than or equal to 1.0% by mass and less than or equal to 4.5% by mass, still more preferably greater than or equal to 1.5% by mass and less than or equal to 4.5% by mass, and particularly preferably greater than or equal to 2.0% by mass and less than or equal to 4.5% by mass in a case where the total content of the positive electrode active material layer 103 is set to 100% by mass. In a case where the content of the conductive assistant is in the above-described range, the balance between the coatability of the positive electrode slurry, the binding property of the binder, and the battery characteristics becomes further excellent.

Further, it is preferable that the content of the conductive assistant is less than or equal to the above-described upper limit from the viewpoint that the proportion of the positive electrode active material is increased and the capacity per positive electrode mass is increased. It is preferable that the content of the conductive assistant is greater than or equal to the above-described lower limit from the viewpoint that the conductivity of the positive electrode is further improved.

The content of the positive electrode active material in the positive electrode active material layer 103 according to the embodiment is preferably greater than or equal to 85% by mass and less than or equal to 99.4% by mass, more preferably greater than or equal to 90.5% by mass and less than or equal to 98.5% by mass, and still more preferably greater than or equal to 90.5% by mass and less than or equal to 97.5% by mass in a case where the total content of the positive electrode active material layer 103 is set to 100% by mass. Further, the content of the binder resin is preferably greater than or equal to 0.1% by mass and less than or equal to 10.0% by mass, more preferably greater than or equal to 0.5% by mass and less than or equal to 5.0% by mass, and still more preferably greater than or equal to 1.0% by mass and less than or equal to 5.0% by mass. Further, the content of the conductive assistant is preferably greater than or equal to 0.5% by mass and less than or equal to 5.0% by mass, more preferably greater than or equal to 1.0% by mass and less than or equal to 4.5% by mass, still more preferably greater than or equal to 1.5% by mass and less than or equal to 4.5% by mass, and particularly preferably greater than or equal to 2.0% by mass and less than or equal to 4.5% by mass.

In a case where the content of each component constituting the positive electrode active material layer 103 is in the above-described range, the balance between the handleability of the positive electrode 100 for a lithium ion battery and the battery characteristics of the obtained lithium ion battery becomes particularly excellent.

The density of the positive electrode active material layer 103 is not particularly limited, but is preferably greater than or equal to 2.0 g/cm³ and less than or equal to 3.6 g/cm³, more preferably greater than or equal to 2.4 g/cm³ and less than or equal to 3.5 g/cm³, and still more preferably greater than or equal to 2.8 g/cm³ and less than or equal to 3.4 g/cm³. It is preferable that the density of the positive electrode active material layer 103 is in the above-described range from the viewpoint that the discharge capacity at the time of using the positive electrode active material layer at a high discharge rate is further improved.

Here, as the density of the positive electrode active material layer is increased, the cycle characteristics of a lithium ion battery to be obtained at a high temperature are likely to be deteriorated. However, the positive electrode 100 for a lithium ion battery according to the present embodiment is capable of suppressing deterioration of the cycle characteristics. Accordingly, from the viewpoint of further improving the energy density of the lithium ion battery to be obtained while improving the cycle characteristics at a high temperature, the density of the positive electrode active material layer 103 is preferably greater than or equal to 2.8 g/cm³. Further, from the viewpoint of further suppressing deterioration of the cycle characteristics at a high temperature, the density of the positive electrode active material layer 103 is preferably less than or equal to 3.6 g/cm³, more preferably less than or equal to 3.5 g/cm³, and still more preferably less than or equal to 3.4 g/cm³.

The thickness of the positive electrode active material layers 103 (the total thickness of the layers on both surfaces thereof) is not particularly limited and can be appropriately set depending on the desired characteristics. For example, the thickness thereof can be set to be large from the viewpoint of the energy density and can be set to be small from the viewpoint of the output characteristics. The thickness of the positive electrode active material layers 103 (the total thickness of the layers on both surfaces thereof) can be appropriately set within the a range of greater than or equal to 10 μm and less than or equal to 500 μm and preferably greater than or equal to 50 μm and less than or equal to 400 μm and more preferably greater than or equal to 100 μm and less than or equal to 300 μm.

Here, as the thickness of the positive electrode active material layers is increased, the cycle characteristics of a lithium ion battery to be obtained at a high temperature are likely to be deteriorated. However, the positive electrode 100 for a lithium ion battery according to the present embodiment is capable of suppressing deterioration of the cycle characteristics. Accordingly, from the viewpoint of further improving the energy density of the lithium ion battery to be obtained while improving the cycle characteristics at a high temperature, the thickness of the positive electrode active material layers 103 (the total thickness of the layers on both surfaces thereof) is preferably greater than or equal to 100 μm, more preferably greater than or equal to 130 μm, and still more preferably greater than or equal to 150 μm. Further, from the viewpoint of further suppressing deterioration of the cycle characteristics at a high temperature, the thickness of the positive electrode active material layers 103 (the total thickness of the layers on both surfaces thereof) is preferably less than or equal to 300 μm, more preferably less than or equal to 250 μm, and still more preferably less than or equal to 200 μm.

Further, the thickness of the positive electrode active material layer 103 (the thickness of one surface thereof) is not particularly limited and can be appropriately set depending on the desired characteristics. For example, the thickness thereof can be set to be large from the viewpoint of the energy density and can be set to be small from the viewpoint of the output characteristics. The thickness of the positive electrode active material layer 103 (the thickness of one surface thereof) can be appropriately set within the a range of greater than or equal to 5 μm and less than or equal to 250 μm and preferably greater than or equal to 25 μm and less than or equal to 200 μm and more preferably greater than or equal to 50 μm and less than or equal to 150 μm.

From the viewpoint of further improving the energy density of the lithium ion battery to be obtained while improving the cycle characteristics at a high temperature, the thickness of the positive electrode active material layer 103 (the thickness of one surface thereof) is preferably greater than or equal to 50 μm, more preferably greater than or equal to 65 μm, and still more preferably greater than or equal to 75 μm. Further, from the viewpoint of further suppressing deterioration of the cycle characteristics at a high temperature, the thickness of the positive electrode active material layer 103 (the thickness of one surface thereof) is preferably less than or equal to 150 μm, more preferably less than or equal to 125 μm, and still more preferably less than or equal to 100 μm.

The specific surface area S of the positive electrode active material according to a nitrogen adsorption BET method is preferably greater than or equal to 0.1 m²/g and less than or equal to 1.0 m²/g, more preferably greater than or equal to 0.2 m²/g and less than or equal to 0.7 m²/g, and still more preferably greater than or equal to 0.2 m²/g and less than or equal to 0.5 m2/g.

Here, according to the present embodiment, in a case where the positive electrode active material layer 103 contains two or more types of positive electrode active materials, the average value of the specific surface areas of all positive electrode active materials contained in the positive electrode active material layer 103 is employed as the specific surface area S.

The collector layer 101 according to the present embodiment is not particularly limited, and examples thereof include aluminum, stainless steel, nickel, titanium, or an alloy of these. Among these, from the viewpoints of the cost, the availability, and the electrochemical stability, aluminum is particularly preferable. Further, the shape of the collector layer 101 is not particularly limited, and examples thereof include a foil shape, a tabular shape, and a mesh shape.

### Method of Producing Positive Electrode for Lithium Ion Battery

Next, a method of producing the positive electrode 100 for a lithium ion battery according to the present embodiment will be described.

The method of producing the positive electrode 100 for a lithium ion battery according to the present embodiment is different from methods of producing electrodes of the related art. In order to obtain the positive electrode 100 for a lithium ion battery according to the present embodiment in which the volume resistivity of the positive electrode 100 for a lithium ion battery is in the above-described range, it is important to highly control the production conditions such as the compounding ratio of the positive electrode active material layer 103, a method of preparing a positive electrode slurry used for forming the positive electrode active material layer 103, a method of drying the positive electrode slurry, a method of pressing the positive electrode, an environment for preparing the positive electrode, and the like. In other words, the positive electrode 100 for a lithium ion battery according to the present embodiment can be obtained for the first time by employing a production method of highly controlling various factors related to the following five conditions of (A) to (E).

(A) The compounding ratio of the positive electrode active material layer 103

(B) The method of preparing a positive electrode slurry used for forming the positive electrode active material layer 103

(C) The method of drying the positive electrode slurry

(D) The method of pressing the positive electrode

(E) The environment for preparing the positive electrode

Here, for example, as the specific production conditions such as the kneading time, the kneading temperature, and the like of the positive electrode slurry, various conditions can be employed on the premise that the positive electrode 100 for a lithium ion battery according to the present embodiment highly controls various factors related to the above-described five conditions. In other words, in regard to the points other than the point of highly controlling various factors related to the above-described five conditions, the positive electrode 100 for a lithium ion battery according to the present embodiment can be prepared by employing a known method.

Hereinafter, an example of the method of producing the positive electrode 100 for a lithium ion battery according to the present embodiment will be described on the premise that various factors related to the above-described five conditions are highly controlled.

It is preferable that the method of producing the positive electrode 100 for a lithium ion battery according to the present embodiment includes the following three steps (1) to (3).

(1) Step of mixing the positive electrode active material, the binder resin, and the conductive assistant to prepare a positive electrode slurry

(2) Step of coating the collector layer 101 with the obtained positive electrode slurry and drying the layer to form the positive electrode active material layers 103

(3) Step of pressing the positive electrode active material layers 103 formed on the collector layer 101 together with the collector layer 101

Hereinafter, each step will be described.

First, (1) the positive electrode active material, the binder resin, and the conductive assistant are mixed to prepare a positive electrode. Since the compounding ratio of the positive electrode active material, the binder resin, and the conductive assistant is the same as the content ratio of the positive electrode active material, the binder resin, and the conductive assistant in the positive electrode active material layer 103, the description thereof will not be provided here.

The positive electrode slurry is obtained by dispersing or dissolving the positive electrode active material, the binder resin, and the conductive assistant in a solvent.

As the procedures of mixing respective components, it is preferable that the positive electrode slurry is prepared by dry-mixing the positive electrode active material and the conductive assistant, adding the binder resin and the solvent thereto, and wet-mixing the components.

In this manner, the dispersibility of the conductive assistant and the binder resin in the positive electrode active material layer 103 is improved, the amount of the conductive assistant and the binder resin at the interface between the collector layer 101 and the positive electrode active material layer 103 can be increased, and the interface resistance between the collector layer 101 and the positive electrode active material layer 103 can be further decreased. As the result, the volume resistivity of the positive electrode 100 for a lithium ion battery can be further decreased.

At this time, the mixer to be used is not particularly limited and a known mixer such as a ball mill or a planetary mixer can be used.

Next, (2) the collector layer 101 is coated with the obtained positive electrode slurry and dried to form the positive electrode active material layers 103. In this step, for example, the collector layer 101 is coated with the positive electrode slurry obtained by performing the step (1), the slurry is dried, and the solvent is removed therefrom so that the positive electrode active material layer 103 is formed on the collector layer 101.

A known method can be typically used as a method of coating the collector layer 101 with the positive electrode slurry. Examples of the method include a reverse roll method, a direct roll method, a doctor blade method, a knife method, an extrusion method, a curtain method, a gravure method, a bar method, a dip method, and a squeeze method. Among these, from the viewpoint that an excellent surface state of a coated layer can be obtained along with the drying property and the physical property such as the viscosity of the positive electrode slurry, a doctor blade method, a knife method, or an extrusion method is preferable.

Both surfaces of the collector layer 101 are coated with the positive electrode slurry. At the time of coating both surfaces of the collector layer 101, the surfaces may be coated sequentially or simultaneously. Further, the surfaces of the collector layer 101 may be coated continuously or intermittently. The thickness, the length, and the width of the coated layer can be appropriately determined depending on the size of the battery.

As a method of drying the positive electrode slurry applied on the collector layer 101, a method of drying the undried positive electrode slurry without directly applying hot air thereto is preferable. Preferred examples thereof include a method of indirectly heating the positive electrode slurry from the collector layer 101 side or the positive electrode active material layer 103 side which has been already dried, using a heating roll, so that the positive electrode slurry is dried; a method of drying the positive electrode slurry using electromagnetic waves such as an infrared heater, afar infrared heater, and a near infrared heater; and a method of drying the positive electrode slurry by applying hot air from the collector layer 101 side or the positive electrode active material layer 103 side which has been already dried so that the positive electrode slurry is indirectly dried.

In this manner, since uneven distribution of the binder resin and the conductive assistant on the surface of the positive electrode active material layer 103 can be suppressed, the amount of the conductive assistant and the binder resin at the interface between the collector layer 101 and the positive electrode active material layer 103 can be increased, and the interface resistance between the collector layer 101 and the positive electrode active material layer 103 can be further decreased. As the result, the volume resistivity of the positive electrode 100 for a lithium ion battery can be further decreased.

Next, (3) the positive electrode active material layers 103 formed on the collector layer 101 are pressed together with the collector layer 101. As a method of pressing the layers, from the viewpoints of increasing the linear pressure and improving the adhesiveness between the positive electrode active material layers 103 and the collector layer 101, roll press is preferable, and the roll press pressure is preferably in a range of 10 to 100 MPa. In this manner, the adhesiveness between the positive electrode active material layers 103 and the collector layer 101 is improved, and the interface resistance between the collector layer 101 and the positive electrode active material layers 103 can be further decreased. As the result, the volume resistivity of the positive electrode 100 for a lithium ion battery can be further decreased.

Here, it is preferable that the above-described three steps (1) to (3) are performed in a dry room (at room. temperature (for example, higher than or equal to 10° C. and lower than or equal to 30° C.) and a dew point temperature of, for example, lower than or equal to −20° C.). In this manner, adsorption of water vapor to each component constituting the positive electrode can be suppressed, and the dispersibility or the coatability of the positive electrode slurry can be improved. In this manner, since uneven distribution of the binder resin and the conductive assistant on the surfaces of the positive electrode active material layers 103 can be suppressed, the amount of the conductive assistant and the binder resin at the interface between the collector layer 101 and the positive electrode active material layers 103 can be increased, and the interface resistance between the collector layer 101 and the positive electrode active material layers 103 can be further decreased. As the result, the volume resistivity of the positive electrode 100 for a lithium ion battery can be further decreased.

### Lithium Ion Battery

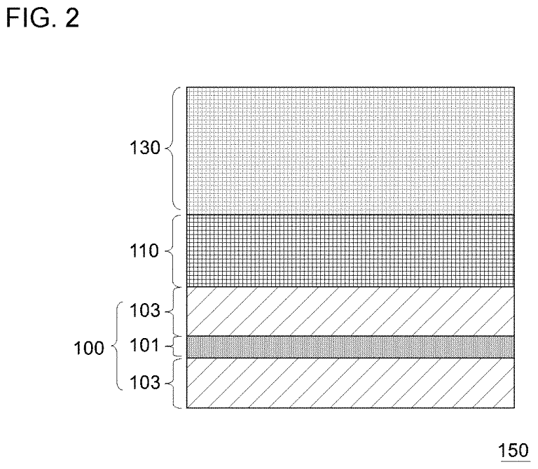

Next, a lithium ion battery 150 according to the present embodiment will be described. FIG. 2 is a cross-sectional view illustrating an example of the structure of the lithium ion battery 150 according to an embodiment of the present invention.

The lithium ion battery 150 according to the present embodiment includes the positive electrode 100 for a lithium ion battery according to the present embodiment. Further, the lithium ion battery 150 according to the present embodiment includes the positive electrode 100 for a lithium ion battery according to the present embodiment, an electrolyte layer 110, and a negative electrode 130. Further, the lithium ion battery 150 according to the present embodiment may include a separator in the electrolyte layer 110 as necessary.

The lithium ion battery 150 according to the present embodiment can be prepared according to a known method.

As the form of the electrode, a laminate or a wound body may be exemplified. Examples of the exterior body include a metal exterior body and an aluminum laminate exterior body. Examples of the shape of the battery include a coin shape, a button shape, a sheet shape, a cylindrical shape, a square shape, and a flat shape.

The negative electrode 130 includes a negative electrode active material; and a binder resin and a negative electrode active material layer containing a conductive assistant as necessary.

Further, the negative electrode 130 includes a negative electrode collector and a negative electrode active material layer provided on this negative electrode collector.

The negative electrode active material according to the present embodiment is not particularly limited as long as the negative electrode active material is a typical material which can be used for a negative electrode of a lithium ion battery. Examples thereof include carbon materials such as natural graphite, artificial graphite, resinous coal, carbon fibers, activated carbon, hard carbon, and soft carbon; lithium-based metal materials such as a lithium metal and a lithium alloy; metal materials such as silicon and tin; and conductive polymer materials such as polyacene, polyacetylene, and polypyrrole. Among these, carbon materials are preferable, and graphite materials such as natural graphite and artificial graphite are particularly preferable.

The negative electrode active material may be used alone or in combination of two or more kinds thereof.

In a case where a lithium metal is used as the negative electrode active material, the negative electrode can be formed using an appropriate system such as a melt cooling system, a liquid quenching system, an atomize system, a vacuum evaporation system, a sputtering system, a plasma CVD system, a photo CVD system, a thermal CVD system, or a sol-gel system. Further, in a case of carbon materials, a negative electrode can be formed according to a method of mixing binder resins such as carbon and polyvinylidene fluoride (PVDF), dispersing and kneading the mixture in a solvent such as NMP, and coating a negative electrode collector with this mixture, a vapor deposition method, a CVD method, or a sputtering method.

From the viewpoint of suppressing side reactions at the time of discharge and charge to suppress a decrease in charge and discharge efficiency, the average particle diameter of the negative electrode active material is preferably greater than or equal to 1 μm, more preferably greater than or equal to 2 μm, and still more preferably greater than or equal to 5 μm. Further, from the viewpoints of input and output characteristics and preparation of the electrode (the smoothness and the like of the surface of the electrode), the average particle diameter thereof is preferably less than or equal to 80 μm and more preferably less than or equal to 40 μm. Here, the average particle diameter indicates the particle diameter (median diameter: D50) with an integrated value of 50% in particle size distribution (on a volume basis) according to a laser diffraction scattering method.

The negative electrode active material layer may contain a conductive assistant or a binder resin as necessary. As the conductive assistant or the binder resin, those which can be used for the positive electrode active material layer 103 described above can be used. Further, as the binder resin, an aqueous binder or the like which can be dispersed in water can also be used.

The aqueous binder is not particularly limited as long as the resin is capable of forming an electrode and sufficiently has electrochemical stability, and examples thereof include a polytetrafluoroethylene-based resin, a polyacrylic acid-based resin, styrene-butadiene-based rubber, and a polyimide-based resin. These aqueous binders may be used alone or in combination of two or more kinds thereof. Among these, styrene-butadiene-based rubber is preferable.

Further, in the present embodiment, the aqueous binder indicates a binder which can be dispersed in water to form an emulsion aqueous solution.

In a case of using the aqueous binder, a thickener may be further used. The thickener is not particularly limited, and examples thereof include water-soluble polymers, for example, cellulose-based polymers such as carboxymethyl cellulose, methyl cellulose, and hydroxypropyl cellulose, aluminum salts of these, and alkali metal salts; polycarboxylic acid; polyethylene oxide; polyvinylpyrrolidone; polyacrylate such as sodium polyacrylate; and polyvinyl alcohol.

As the negative electrode collector, copper, stainless steel, nickel, titanium, or an alloy of these can be used. Among these, from the viewpoints of the cost, the availability, and the electrochemical stability, copper is particularly preferable. Further, the shape of the negative electrode collector is not particularly limited, and examples thereof include a foil shape, a tabular shape, and a mesh shape.

All known lithium salts can be used as the electrolyte used for the electrolyte layer 110, and the electrolyte may be selected depending on the type of the electrode active material. Examples thereof include LiClO₄, LiBF₆, LiPF₆, LiCF₃SO₃, LiCF₃CO₂, LiAsF₆, LiSbF₆, LiB₁₀Cl₁₀, LiAlCl₄, LiCl, LiBr, LiB(C₂H₅)₄, CF₃SO₃Li, CH₃SO₃Li, LiCF₃SO₃, LiC₄F₉SO₃, Li(CF₃SO₂)₂N, and lower fatty acid lithium carboxylate.

The solvent that dissolves the electrolyte used for the electrolyte layer 110 is not particularly limited as long as the solvent is typically used as a liquid component that dissolves an electrolyte. Examples thereof include carbonates such as ethylene carbonate (EC), propylene carbonate (PC), butylene carbonate (BC), dimethyl carbonate (DMC), diethyl carbonate (DEC), methyl ethyl carbonate (MEC), and vinylene carbonate (VC); lactones such as γ-butyrolactone and γ-valerolactone; ethers such as trimethoxymethane, 1,2-dimethoxyethane, diethyl ether, 2-ethoxyethane, tetrahydrofuran, and 2-methyl tetrahydrofuran; sulfoxides such as dimethyl sulfoxide; oxolanes such as 1,3-dioxolane and 4-methyl-1,3-dioxolane; nitrogen-containing solvents such as acetonitrile, nitromethane, formamide, and dimethylformamide; organic acid esters such as methyl formate, methyl acetate, ethyl acetate, butyl acetate, methyl propionate, and ethyl propionate; phosphoric acid trimester and diglymes; triglymes; sulfolanes such as sulfolane and methyl sulfolane; oxazolidinones such as 3-methyl-2-oxazolidinone; and sultones such as 1,3-propane sultone, 1,4-butane sultone, and naphthasultone. These may be used alone or in combination of two or more kinds thereof.

As the separator, a porous separator is exemplified. Examples of the shape of the separator include a membrane, a film, and non-woven fabric.

Examples of the porous separator include a porous polyolefin-based separator such as a polypropylene-based separator or a polyethylene-based separator; and a porous separator formed of polyvinylidene fluoride, polyethylene oxide, polyacrylonitrile, or a polyvinylidene fluoride hexafluoropropylene copolymer.

Hereinbefore, the embodiments of the present invention have been described, but these are merely examples of the present invention, and various configurations other than these examples may be employed.

Further, the present invention is not limited to the above-described embodiment, and modifications, improvements, and the like can be made within the range where the purpose of the present invention can be achieved.

### EXAMPLES

Hereinafter, the present invention will be described based on the following examples and comparative examples, but the present invention is not limited thereto.

### Example 1

### Preparation of Positive Electrode

A mixture (lithium-nickel composite oxide/lithium-manganese composite oxide=20/80 (mass ratio)) of a lithium-nickel composite oxide (LiNiO₂, specific surface area of 0.5 m²/g) and a lithium-manganese composite oxide (LiMn₂O₄, specific surface area of 0.26 m²/g), carbon black (specific surface area of 62 m²/g), and polyvinylidene fluoride were respectively used as the positive electrode active material 1, the conductive assistant 1, and a binder resin.

First, the positive electrode active material 1 and the conductive assistant 1 were dry-mixed. Next, the binder resin and N-methyl-pyrrolidone (NMP) were added to the obtained mixture, and the mixture was wet-mixed to prepare a positive electrode slurry. Both surfaces of aluminum foil with a thickness of 20 μm serving as a positive electrode collector were continuously coated with the positive electrode slurry and dried to prepare a positive electrode roll including a positive electrode collector provided with a coated portion and an uncoated portion. Here, the positive electrode slurry was dried by being indirectly heated using a heating roll at 120° C. from the aluminum foil side or the positive electrode active material layer side which had been already dried. By drying the positive electrode slurry, NMP in the positive electrode slurry was removed so that positive electrode active material layer (thickness of 158 μm (total thickness of the layers on both surfaces) was formed on the aluminum foil.

Next, the aluminum foil and the positive electrode active material layer were pressed at a pressing pressure of 20 MPa through roll press, thereby obtaining a positive electrode. The density of the obtained positive electrode active material layer was 2.97 g/cm³.

Further, the compounding ratio between the positive electrode active material, the conductive assistant, and the binder resin (positive electrode active material/conductive assistant/binder resin) was 93/3/4 (mass ratio). In addition, the above-described steps were all performed in a dry room (temperature of 23° C., dew point temperature of lower than or equal to −20° C.)

### Preparation of Negative Electrode

Artificial graphite and polyvinylidene fluoride (PVdF) were respectively used as a negative electrode active material and a binder resin. These were dispersed in N-methyl-pyrrolidone (NMP) to prepare a negative electrode slurry. Next, copper foil with a thickness of 15 μm serving as a negative electrode collector was continuously coated with the negative electrode slurry and dried to prepare a negative electrode roll including a negative electrode collector provided with a coated portion and an uncoated portion.

### Preparation of Lithium Ion Battery

The obtained positive electrode and negative electrode were laminated through a porous polyolefin-based separator, a negative electrode terminal and a positive electrode terminal were provided thereon, thereby obtaining a laminate. Next, a lithium ion battery was obtained by accommodating an electrolytic solution obtained by dissolving 1 M LiPF₆ in a solvent formed of ethylene carbonate and diethyl carbonate and the obtained laminate with a flexible film.

### Evaluation

### (1) Measurement of Volume Resistivity of Positive Electrode

The volume resistivity of the positive electrode was measured by interposing the positive electrode using a terminal probe in the normal direction of the thickness thereof at a load of 1 kg/cm² and connecting a measurement terminal to this terminal probe according to the four terminal method.

### (2) Measurement of S/W

A specific surface area S₁ [m²/g] of a lithium-nickel composite oxide and a specific surface area S₂ [m²/g] of a lithium-manganese composite oxide were respectively measured according to a nitrogen absorption BET method. Next, S/W was calculated using Equation (1) by setting the content of the conductive assistant in the positive electrode active material layer as W [% by mass], the mass ratio of the lithium-nickel composite oxide in the positive electrode active material as W₁ [-], and the mass ratio of the lithium-manganese composite oxide in the positive electrode active material as W₂ [-].

S/W=(S₁×W₁+S₂×W₂)/W (1)

### (3) Cycle Characteristics at High Temperature

The cycle characteristics at a high temperature were evaluated using the lithium ion battery. At a temperature of 45° C., CCCV charge and CC discharge were performed by setting the charge rate to 1.0 C, the discharge rate to 1.0 C, the charge termination voltage to 4.15 V, and the discharge termination voltage to 2.5 V. The capacity retention rate (%) is a value obtained by dividing a discharge capacity (mAh) after 500 cycles by a discharge capacity (mAh) at the 10-th cycle. The cycle characteristics at a high temperature were evaluated as A in a case where the capacity retention rate (%) was greater than 85%, the cycle characteristics at a high temperature were evaluated as B in a case where the capacity retention rate (%) was greater than 80% and less than or equal to 85%, and the cycle characteristics at a high temperature were evaluated as C in a case where the capacity retention rate (%) was less than or equal to 80%.

### Example 2

A positive electrode and a lithium ion battery were prepared in the same manner as in Example 1 except that a mixture (lithium-nickel composite oxide/lithium-manganese composite oxide =22/78 (mass ratio)) of a lithium-nickel composite oxide (LiNiO₂, specific surface area of 0.5 m²/g) and a lithium-manganese composite oxide (LiMn₂O₄, specific surface area of 0.43 m²/g) was used as a positive electrode active material and the compounding ratio between the positive electrode active material, the conductive assistant, and the binder resin was changed to 92/4/4 (mass ratio), and each evaluation was performed.

### Comparative Example 1

A positive electrode and a lithium ion battery were prepared in the same manner as in Example 1 except that the lithium-manganese composite oxide (LiMn₂O₄) having a specific surface area of 0.26 m²/g was changed to a lithium-manganese composite oxide having a specific surface area of 0.43 m²/g, and each evaluation was performed.

### Comparative Example 2

A positive electrode and a lithium ion battery were prepared in the same manner as in Comparative Example 1 except that the density of the positive electrode active material layer was changed to 3.10 g/cm³ from 2.97 g/cm³, and each evaluation was performed.

### Comparative Example 3

A positive electrode and a lithium ion battery were prepared in the same manner as in Comparative Example 1 except that the density of the positive electrode active material layer was changed to 2.80 g/cm³ from 2.97 g/cm³, and each evaluation was performed.

### Comparative Example 4

A positive electrode and a lithium ion battery were prepared in the same manner as in Comparative Example 1 except that the compounding ratio between the positive electrode active material, the conductive assistant, and the binder resin was changed to 94/3/3 (mass ratio), and each evaluation was performed.

### Comparative Example 5

A positive electrode and a lithium ion battery were prepared in the same manner as in Example 2 except that the specific surface area of the lithium-manganese composite oxide (LiMn₂O₄) was changed to 0.26 m²/g from 0.43 m²/g, and each evaluation was performed.

### Comparative Example 6

A positive electrode and a lithium ion battery were prepared in the same manner as in Example 2 except that the specific surface area of the lithium-manganese composite oxide (LiMn₂O₄) was changed to 0.30 m²/g from 0.43 m²/g, and each evaluation was performed.

The evaluation results are listed in Table 1.

TABLE 1

| | | | Comparative | Comparative | Comparative | Comparative | Comparative | Comparative |
|---|---|---|---|---|---|---|---|---|
| | Example 1 | Example 2 | Example 1 | Example 2 | Example 3 | Example 4 | Example 5 | Example 6 |
| Volume | 165 | 151 | 416 | 389 | 443 | 282 | 104 | 98 |
| resistivity | | | | | | | | |
| [Ω · m] | | | | | | | | |
| S/W[m²/g] | 0.103 | 0.111 | 0.148 | 0.148 | 0.148 | 0.148 | 0.078 | 0.086 |
| Cycle | A | B | C | C | C | C | C | C |
| characteristics | | | | | | | | |
| at high | | | | | | | | |
| temperature | | | | | | | | |

Based on Table 1, the lithium ion battery of each example in which the volume resistivity of the positive electrode and S/W were respectively in the range of the invention of the present application had excellent cycle characteristics at a high temperature. On the contrary, the lithium ion battery of each comparative example in which at least one of the volume resistivity of the positive electrode and S/W was out of the range of the invention of the present application had degraded cycle characteristics at a high temperature.

This application claims priority based on Japanese Patent Application No. 2017-031840 filed on Feb. 23, 2017, the entire contents of which are incorporated herein by reference.

1. A positive electrode for a lithium ion battery, comprising:
a collector layer; and
a positive electrode active material layer which is provided on each of both surfaces of the collector layer and contains a positive electrode active material, a binder resin, and a conductive assistant,
wherein a volume resistivity of the positive electrode for a lithium ion battery is greater than or equal to 120 Ω·m and less than or equal to 350 Ω·m, and
in a case where a specific surface area of the positive electrode active material contained in the positive electrode active material layer is set as S [m²/g] and a content of the conductive assistant in the positive electrode active material layer is set as W [% by mass], S/W is greater than or equal to 0.080 and less than or equal to 0.140.

2. The positive electrode for a lithium ion battery according to claim 1,
wherein a density of the positive electrode active material layer is greater than or equal to 2.8 g/cm³ and less than or equal to 3.6 g/cm³.

3. The positive electrode for a lithium ion battery according to claim 1,
wherein the positive electrode active material contains a composite oxide of lithium and a transition metal.

4. The positive electrode for a lithium ion battery according to claim 1,
wherein the binder resin contains a fluorine-based binder resin.

5. The positive electrode for a lithium ion battery according to claim 1,
wherein, in a case where a total content of the positive electrode active material layer is set to 100% by mass, a content of the binder resin is greater than or equal to 0.1% by mass and less than or equal to 10.0% by mass.

6. The positive electrode for a lithium ion battery according to claim 1,
wherein, in a case where a total content of the positive electrode active material layer is set to 100% by mass, a content of the conductive assistant is greater than or equal to 0.5% by mass and less than or equal to 5.0% by mass.

7. The positive electrode for a lithium ion battery according to claim 1,
wherein a thickness of the positive electrode active material layer is greater than or equal to 100 μm and less than or equal to 300 μm.

8. A lithium ion battery comprising:
the positive electrode for a lithium ion battery according to claim 1.
